(19) United States
(12) Patent Application Publication
(10) Pub. No.: US 2005/0240479 A1
(43) Pub. Date: Oct. 27, 2005

(54) Processing method for pos system

(75) Inventor: Masakazu Ito, Kanagawa (JP)

Correspondence Address: FOLEY AND LARDNER;SUITE 500, 3000 K STREET NW, WASHINGTON, DC, 20007, US

(73) Assignee: NEC Infrontia Corporation

(21) Appl. No.: 11/063,719

(22) Filed: Feb. 24, 2005

(30) Foreign Application Priority Data
Feb. 13, 2003 (JP) 2003-035203

(51) Int. Cl. G06F 17/60

(52) U.S. Cl. 705/16

(57) ABSTRACT

A specific process execution system for a POS system for executing goods sales process, a predetermined item report process and a predetermined item registration process is disclosed. Peculiar function numbers are assigned to functions, respectively, for executing specific processes at predetermined timings, the peculiar function numbers and the functions being stored in correspondence to one another in a function table. In response to the designation of a function number corresponding to a specific process, a corresponding function is read out from the function table and executed.

### BACKGROUND OF INVENTION

The present invention relates to a specific process execution system for a POS system and, more particularly, to a specific process execution system for a POS system capable of report and process registration in a POS system with simple operation.

In fast food shops and convenience stores, it is necessary in management to execute sales summation and report output of sales by persons in charge and sales of different goods in daily management. In such report output, usually an operator or a manager executes a key operation to display the report output operation view and output a predetermined report.

For example, in many cases of management a report of sales by different persons in charge, a report of sales of different goods, etc., are outputted at least once a day. Also, in many cases stock registration, a present cash amount registration, etc. is executed. Usually, a key switch is provided in a POS terminal. When executing a specific operation as noted above, the key switch is operated to raise a menu on a display screen in correspondence to a predetermined mode (for instance a management mode). Then, a necessary “report” operation is selected to select a desired subject report item for the output from the raised report selection menu. In this way, a pertinent report content is outputted. Where such a key switch is not provided, a substitute report mode key is operated (usually a key on a touch panel is touched) to raise a menu in correspondence to the management mode. Then, like the above case, the necessary “report” operation is selected to select a desired subject report item for the output from the raised report selection menu, whereby the pertinent report content is outputted.

The registration process is executed likewise. In this case, the key switch is operated to set a master registration mode and raise a master registration item menu on the display screen. From this menu, a master is selected to execute the necessary process. Where no such switch key is provided, a substitute registration mode key (i.e., manager mode key) is operated (key touch on touch panel is made) to raise the master registration item menu. From this menu, the master is selected to execute the necessary process.

FIGS. 5(A) and 5(B) show displays for describing the prior art operation for the report output. FIG. 5(A) shows a view of goods and a goods sales view with a showing of sales data. For the report output, for instance, the key switch is operated to set management 1. As a result, as shown in FIG. 5(B), a report selection view with a showing of “1: Daily sum report” and “2: Summation report” is displayed. In this state, the ten key set as shown is touched to select one of the two report items. A report of the selected item is thus outputted.

FIGS. 6(A) and 6(B) show a display example when the “1: Daily sum report” is selected by operating the ten key set shown in FIG. 5(B). FIG. 6(A) shows detail items in the selected “1: Daily sum report” (specifically “1: Persons in charge”, “2: Time zones”, “3: Goods”, “4: Stock management” and “5: Negligence”). Among these detail items, a desired one is selected by operating the ten key set. For example, by selecting the “3: Goods” report, a goods report is displayed as shown in FIG. 6(B). This content is printed by a printer.

As shown above, for report output or registration process in the prior art, a report item view or a registration item view is displayed by a specific operation of the key switch or the like, and the desired report or registration item is selected from among the displayed items, whereby the corresponding report or registration view is displayed. Therefore, it is necessary to execute the above operation whenever the report output or registration process is made, thus posing operability problems.

For improving such operability, a terminal utilizing a MACRO function has been in practical use. A sequence of processes is registered in a registration area of the MACRO function, and is automatically executed by executing the pertinent MACRO key. The MACRO is assigned to a key, and it is arranged such that the report output, for instance, can be made by touching the key with the MACRO assigned thereto.

As shown above, in the prior art, for executing the report output or registration process a desired item is selected from a report item view displayed by a specific operation of the key switch or the like, whereby the corresponding report or registration view is displayed and outputted. However, whenever the report output or registration process is executed, a cumbersome operation is required, thus posing operability problems.

In the meantime, there is a terminal for automatically executing a sequence of processes registered in a registration area. However, for registering a sequence of processes with the MACRO function, the designation of a registration area corresponding to a MACRO function number, the designation of the attribute (PLU, FUNCTION, MACRO) to the registration area and number, etc., have to be independently and successively made by manual input. Besides, it is necessary to grasp the contents to be registered. Therefore, operability problems still remain.

### SUMMARY OF INVENTION

An object of the present invention, accordingly, is to provide a specific process execution system for a POS system capable of ensuring satisfactory operability and fast executing specific operations such as report, registration, etc.

As an embodiment of the present invention, a specific process execution system for a POS system for executing a goods sales process, a predetermined item report process and a predetermined item registration process, is provided. In the system, peculiar function numbers are assigned to functions, respectively, for executing specific processes at predetermined timing, the peculiar function numbers and the functions being stored in correspondence to one another in a function table, and in response to the designation of a function member corresponding to a specific process, a corresponding function is read out from the function table and executed.

The specific process is the report process or the registration process. A MACRO function process part is further provided, which executes a MACRO function process when this process is designated.

Other objects and features of the present invention will become more apparent from the following description when the same is read with reference to the accompanying drawings, in which:

### BRIEF DESCRIPTION OF DRAWINGS

FIG. 1 is a flow chart illustrating the process sequence in an embodiment of the specific process execution system for a POS system according to the present invention;

FIG. 2 is a view showing an example of function table in the embodiment of the present invention;

FIGS. 3(A) and 3(B) are views showing an example of display views in the embodiment of the present invention;

FIG. 4 is a block diagram showing the process arrangement of the embodiment of the present invention;

FIGS. 5(A) and 5 (B) show display views for describing the operation for report output in the prior art; and

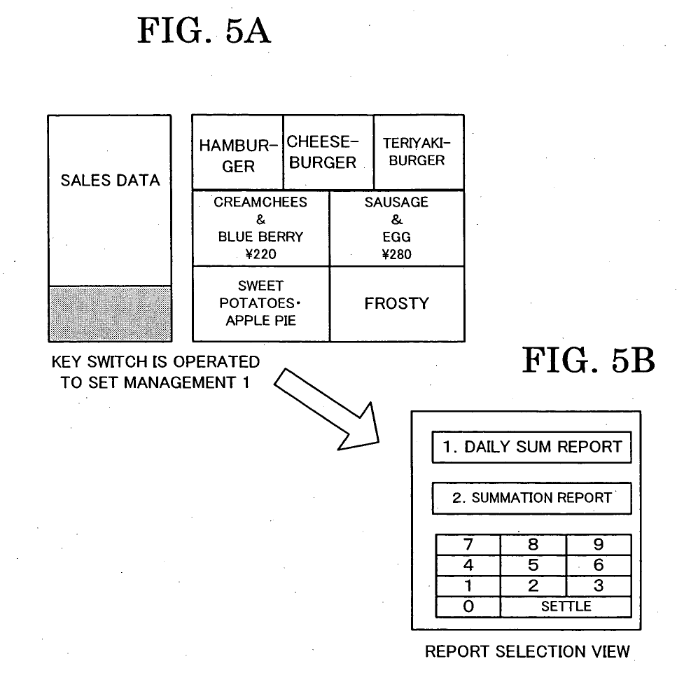

FIGS. 6(A) and 6(B) are views showing an example of display when “1: Daily sum report” is selected by ten key set operation.

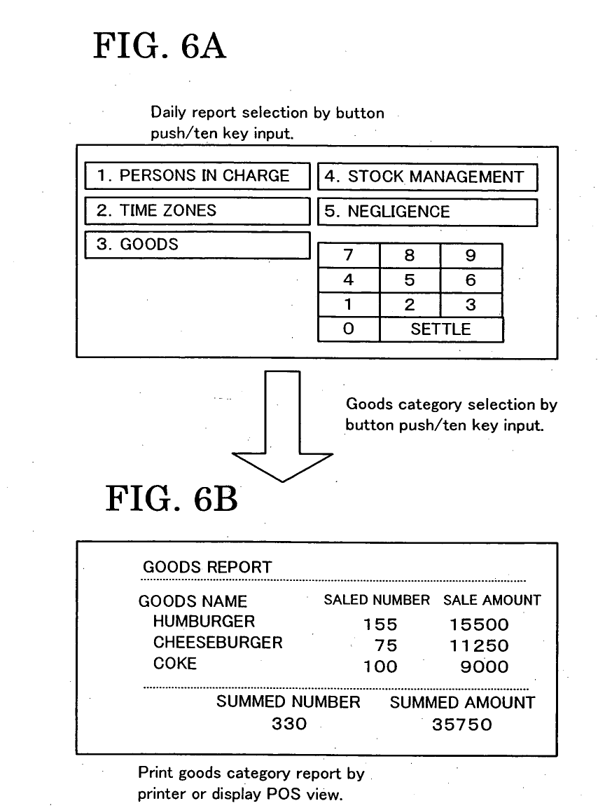

### PREFERRED EMBODIMENTS OF INVENTION

Preferred embodiments of the specific process execution system for a POS system according to the present invention will now described in details with reference to the accompanying drawings.

In the present invention, peculiar function numbers are assigned to specific processes, respectively, such as report and registration processes, and are stored together with functions for executing them, respectively, in a function table. These numbers are each assigned to each key. Thus, when a pertinent function key is touched (i.e., operated), the corresponding peculiar function is called and executed according to the data registered in the function table.

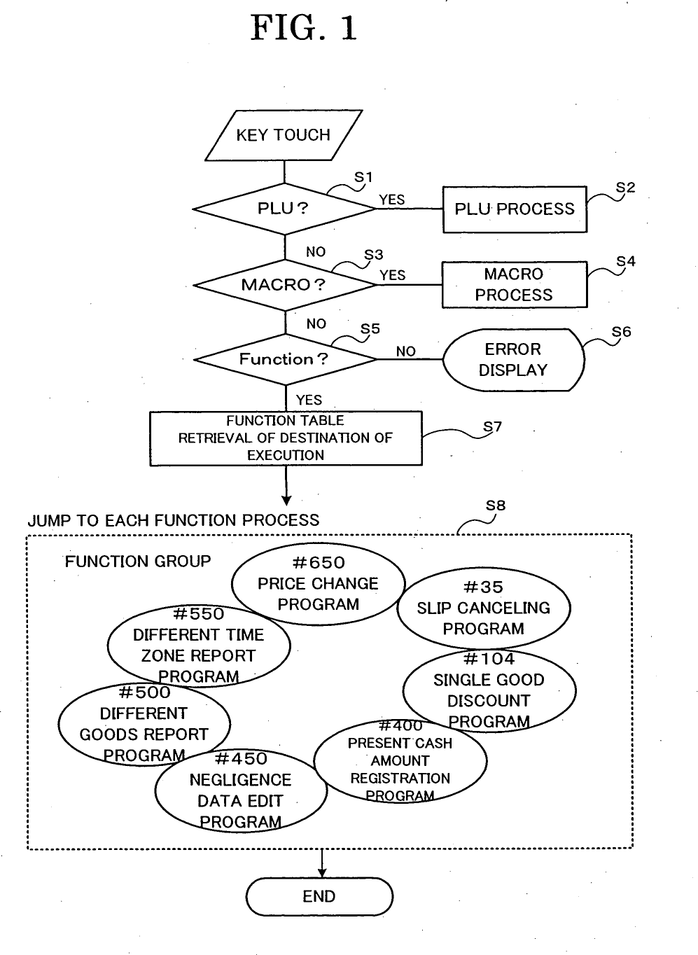

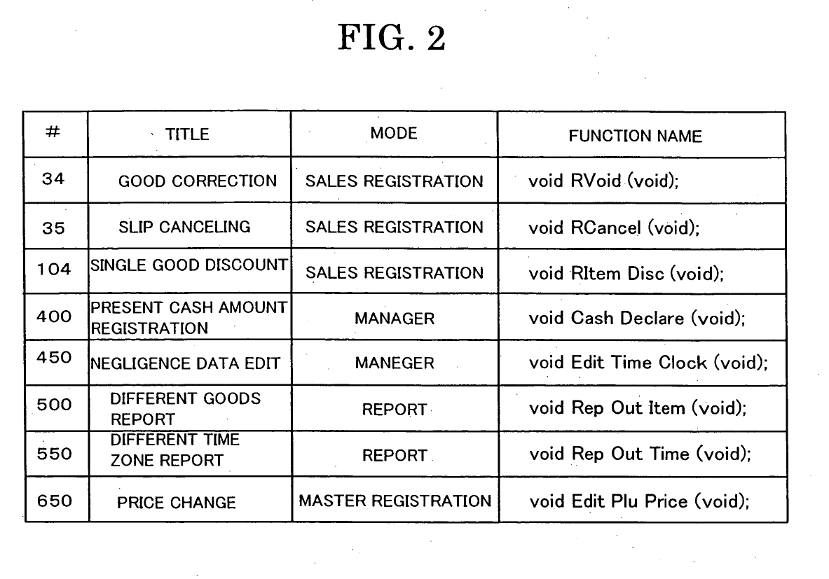

FIG. 1 is a flow chart illustrating the process sequence of the embodiment of the specific process execution system for a POS system according to the present invention. FIG. 2 shows an example of the function table. In the example shown in FIG. 2, goods correction (sales registration mode), slip canceling (sales registration mode), single good discount (sales registration mode), present cash amount registration (manager mode), negligence data edit (manager mode), different goods report (report mode), different time zone report (report mode) and price change (master registration mode), are assigned to function numbers 34, 35, 104, 400, 450, 500, 550 and 650, respectively. Each title is provided with a function name. A function table is provided, in which destinations of execution of the function numbers are registered.

The process routine of the embodiment of the present invention will be described with reference to FIG. 1. When a predetermined key in a touch view on a touch panel is touched, a check is made with reference to the content of the touched key as to whether the pertinent process is relevant to PLU (i.e., goods) (step S1). When the process is relevant to PLU, a PLU process is executed (step S2). Otherwise, a check is made as to whether the touched key is a MACRO key (step S3). When it is found in the step S3 that the touched key is the MACRO key, a MACRO process is executed (step S4). Otherwise, a check is made as to whether the function process is designated (step S5). When it is found in the step S5 that no function process is designated, no process is designated. Thus, an error display is made (step S6). When it is found that the function process is designated, the destination of execution corresponding to the pertinent to the unction number is retrieved with reference to the function table (step S7). After the retrieval, the routine jumps to and executes the retrieved (i.e., designated) function process (step S8), thus bringing an end to the routine.

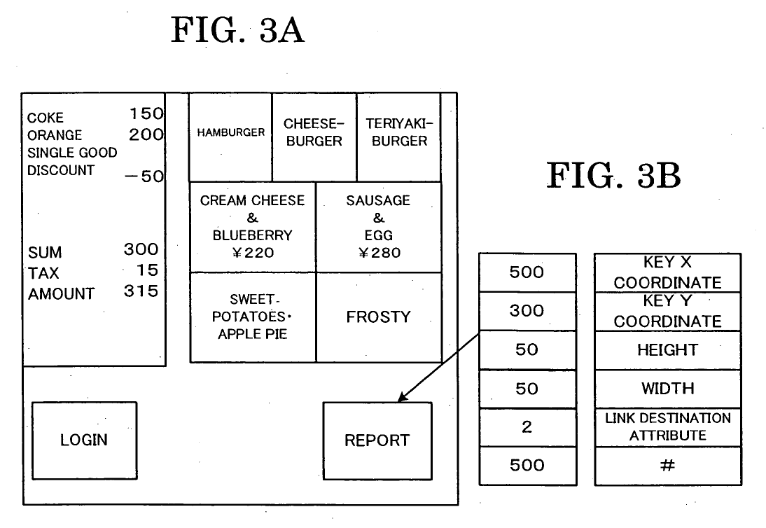

FIGS. 3(A) and 3(B) show an example of display views in the embodiment of the present invention. FIG. 3(A) shows an example of the usual goods sales view. This display is raised by log-in key operation. Here, a report key is displayed on the view by a predetermined operation. As well as the report key, a registration key is displayed by a predetermined operation. While a key corresponding to a predetermined function number is displayed in the view, it is of course possible as well that a plurality of keys is displayed.

The report key is defined as shown in FIG. 3(B). The definition is such that Key X coordinate: 500, Key Y coordinate: 300, Height: 50, Width: 50, Link destination attribute: 2 and Function number: 500. In the case of this example, a function process is designated from “Link destination attribute: 2” with reference to the definition and content of the touched report key, the “different goods report” shown in FIG. 2 is recognized from the function number of “500”, and finally the “different goods report” is displayed and outputted.

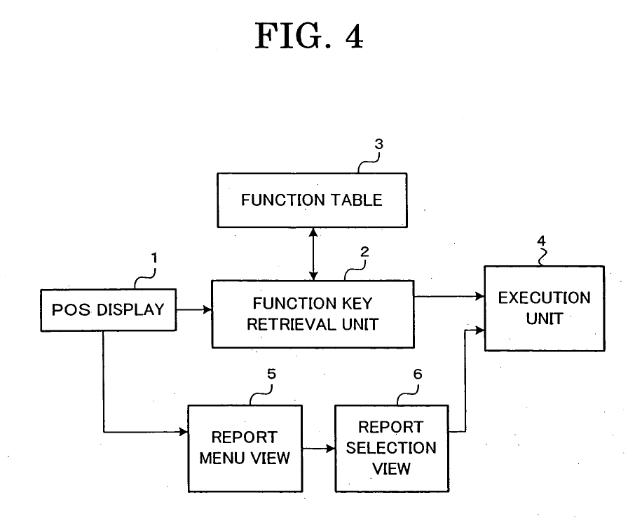

FIG. 4 is a block diagram showing the process arrangement of the embodiment of the present invention. Referring to FIG. 4, when a function number for executing a predetermined report, registration, etc., process, provided in a goods sales (POS) view 1 on the display (see FIG. 3(A)), is touched and designated, a function key retrieval unit 2 reads out a function corresponding to the designated function number with reference to a function table 3. An execution unit 4 executes the read-out function directly, and displays the result on the display. The embodiment shown in FIG. 4 may further comprise a process unit for executing a MACRO function process as in the prior art to improve the expansibility and versatility. Specifically, in the goods sales view 1 on the display (see FIG. 3(A), a report menu view 5 and a report selection view 6 are displayed by specific operations of a key switch or the like, and the execution unit 4 executed a process of displaying and outputting a corresponding report or registration view selected from among the displayed views.

As has been described in the foregoing, in the specific process execution system for a POS system according to the present invention, peculiar function numbers are assigned to specific processes, respectively, such as report, registration, etc. processes and stored as a function table. These numbers are each assigned to each key. When a function number is designated, the pertinent peculiar function registered in the function table is called and executed. Thus, a cumbersome MACRO registration operation as in the prior art is unnecessary. It is thus possible to obtain pronounced effects that not only the operability is greatly improved, but also specific operations such as report and registration can be executed satisfactorily and speedily.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

1. A specific process execution system for a POS system for executing goods sales process, a predetermined item report process and a predetermined item registration process, wherein:
peculiar function numbers are assigned to functions, respectively, for executing specific processes at predetermined timings, the peculiar function numbers and the functions being stored in correspondence to one another in a function table; and
in response to a designation of the function number corresponding to the specific process, a corresponding function is read out from the function table and executed.

2. The specific process execution process for a POS system according to claim 1, wherein the specific process is the report process or the registration process.

3. The specific process execution system for a POS system according to claim 1, which also comprises a MARCO function process part for executing a MARCO function process when the same is designated.
